(19) United States
(12) Patent Application Publication
(10) Pub. No.: US 2011/0101672 A1
(43) Pub. Date: May 5, 2011

(54) DEVICE FOR GRIPPING AN EXHAUST PIPE

(76) Inventor: Fredrik Bergling, Nyhmanslage (SE)

(21) Appl. No.: 12/995,546

(22) PCT Filed: May 28, 2009
(86) PCT No.: PCT/SE2009/050609

§ 371 Date: Dec. 28, 2010

(30) Foreign Application Priority Data
Jun. 2, 2008 (SE) 0801300-5

(51) Int. Cl. F16L 37/02; F16L 25/00

(52) U.S. Cl. 285/31

(57) ABSTRACT

Device for internal gripping of an exhaust pipe having a gripping device which in turn has a first and a second protrusion, which are mutually connected to allow mutual displacement along a first axis (A), in which this displacement imposes a mutual change of position of the first and second protrusions along a second axis (B), perpendicular to the first axis. The device also has a manoeuvering device for achieving the mutual displacement of the two protrusions. The manoeuvering device comprises an advancement unit arranged to displace the first protrusion along the first axis (A) in relation to the manoeuvering device, and a connecting link, which connects the manoeuvering device to the second protrusion and which limits the displacement of said second protrusion along the first axis (A) relative to the manoeuvering device during the displacement of the first protrusion by the advancement unit.

### FIELD OF THE INVENTION

The invention relates to a device for internal gripping of an exhaust pipe.

### BACKGROUND OF THE INVENTION

Extraction devices in which a connection element in the form of a hose or nozzle is connected to an exhaust-gas source are commonly found. A typical example is inspection halls, assembly halls, workshops or parking halls for emergency vehicles, in which the connection element is connected to the exhaust pipe of the vehicle. This can be realized by the exhaust pipe being gripped either externally or internally. The most commonly found method is external gripping, quite simply because the exhaust pipe has traditionally been a protruding part which is more or less freely accessible. The trend shows however that the exhaust pipe, for design reasons, has been and will be moved in beneath and behind the rear fender and bumper of the vehicle, which reduces the access and more or less renders external gripping impossible.

A first example of internal gripping of an exhaust pipe is shown in DE 20121781U1, which describes a mechanism in which the exhaust pipe is gripped by means of two jaws, which are radially displaced toward the internal walls of the exhaust pipe. The radial motion is achieved by axial displacement of a centrally arranged threaded axle. The axial displacement is converted by a scissor-type link mechanism into a radial motion of the jaws. The threaded axle is manoeuvered by means of a crank. The drawback with this solution is that it is time-consuming to manoeuver. In addition, it is difficult to combine with a flexible hose, since the central axle and the crank require in practice a 90-degree bend for free access.

Another principle for internal gripping is given by DE 19533183C2, in which the internal gripping is realized by means of an inflatable bellows. This entails a detrimental constriction of the exhaust-gas flow through the exhaust pipe. The solution is time-consuming, moreover, since the bellows must be inflated to a suitable volume for gripping and must subsequently be ventilated for release.

A third basic solution is given by U.S. Pat. No. 4,906,032, which employs a U-clamp having two resilient legs, which are introduced into the exhaust pipe for internal gripping of the exhaust pipe. For release, an axial traction motion which overcomes the friction between the legs and the inner side of the exhaust pipe is required, which risks damaging the exhaust pipe. The solution is simple but the grip will vary between different vehicle models, depending on the dimensions of the exhaust pipe.

Starting from these basic solutions, there is a need for a simple gripping device which allows quick, easy and reliable internal gripping and release of an exhaust pipe, regardless of the exhaust pipe size.

### OBJECTS OF THE PRESENT INVENTION

One object of the invention is to provide a device for internal gripping of an exhaust pipe, which device allows quick and easy gripping and release.

Another object is that the device shall allow manoeuvering with a single-handed grip.

One more object is that the device shall have the least possible effect upon the exhaust-gas flow through the exhaust pipe.

The device shall also be able to be used regardless of whether the extraction device is provided with a flexible hose or a fixed pipe system.

### SUMMARY OF THE INVENTION

In order to achieve the above-specified and further unspecified objects, which will emerge from the following description, the present invention relates to a device for internal gripping of an exhaust pipe, comprising a gripping device comprising a first and a second protrusion which are mutually connected to allow mutual displacement along a first axis, the connection being arranged such that a displacement along said first axis imposes a mutual change of position of the first and second protrusions along a second axis, perpendicular to the first axis, a manoeuvering device for achieving said mutual displacement of the first and second protrusions along said first axis, which manoeuvering device comprises an advancement unit arranged to displace the first protrusion along said first axis in relation to the manoeuvering device, and a connecting link, which is arranged to connect the manoeuvering device to the second protrusion and to limit the displacement of said second protrusion along the first axis relative to said manoeuvering device during the displacement of the first protrusion by the advancement unit.

By virtue of the invention, a device is provided which is intended for internal gripping of an exhaust pipe for the connection thereto of an extraction device. The device according to the invention comprises two main parts, namely a gripping device for gripping the exhaust pipe and a manoeuvering device for manoeuvering the gripping device. The gripping device comprises two protrusions, which are intended to be introduced into the exhaust pipe, whereafter they are moved apart by means of the manoeuvering device in the radial direction of the exhaust pipe for internal gripping of the exhaust pipe. More precisely, when the first protrusion, by means of the manoeuvering device, is guided along the first axis, i.e. in the axial direction of the exhaust pipe, this imposes upon the second protrusion a pendulum motion, which means that this is shifted with a translation motion along a second axis which is perpendicular to the first axis. The two protrusions will thereby be moved apart in the radial direction of the exhaust pipe, for internal gripping of the same.

The fact that the internal gripping is realized by means of two protrusions which can be given a very limited cross section means that the least possible effect is made upon the exhaust-gas flow.

The device can be used regardless of the radial dimension of the exhaust pipe. In addition, the manoeuvering device is configured such that it can be manoeuvered from a position along the longitudinal axis of the device, so that it can be used regardless of whether the extraction device is provided with a flexible hose or a fixed pipe system.

The advancement unit can comprise an advancement member, which is adjustable relative to the first protrusion between a first and a second position, in which first position the first protrusion is allowed to be displaced along said first axis relative to the advancement member, and in which second position the advancement member lockingly engages with the first protrusion, the advancement member in its second position being arranged to be displaced along said first axis and thus to displace said first protrusion along said first axis in relation to the manoeuvering device.

The advancement of the first protrusion is thus realized by the advancement member being alternately adjusted between its first and second position. Each time the advancement member assumes its second position, it lockingly engages with the first protrusion, which causes it, together with the first protrusion, to be guided forward along the first axis. As a consequence of the connection between the first and second protrusion, the advancement of the first protrusion along the first axis will result in the two protrusions being moved apart along the second axis, thereby allowing an internal radial gripping of an exhaust pipe.

When the advancement member, on the other hand, is set in its first position, the first protrusion is allowed to be displaced relative to the advancement member along the first axis, whereby the first and second protrusion can be brought together and can release their internal radial engagement with an exhaust pipe.

The advancement member can be formed by a washer comprising a cutout cooperating with the first protrusion, which washer, in the first position of the advancement member, can be arranged guidably over said first protrusion, and which washer, in the second position of the advancement member, by tilting, lockingly engages with the first protrusion by means of a gripping surface arranged in the cutout. The use of an advancement member in the form of a washer is advantageous, since the gripping surface in its simplest embodiment can be formed by the rim of the hole edge of the cutout.

The advancement member can be pretensioned in the direction of the first position. This means that the advancement member in its neutral position does not lockingly engage with the first protrusion.

The manoeuvering device can further comprise a locking unit comprising a locking member which is adjustable relative to the first protrusion between a first and a second position, in which first position said locking member lockingly engages with the first protrusion, and in which second position the first protrusion is allowed to be displaced along said first axis relative to the locking member.

The locking member can be formed by a washer comprising a cutout cooperating with the first protrusion, which washer, in the second position of the locking member, is arranged guidably over said first protrusion, and which washer, in the first position of the locking member, by tilting, lockingly engages with the first protrusion by means of a gripping surface arranged in the cutout. When the locking unit is manoeuvered, i.e. the locking member is guided to its second position, the first protrusion can be guided along the first axis. The locking member is thus intended to be manoeuvered when the engagement of the gripping member with an exhaust pipe is to be released. The user then guides the locking member into its second position, at the same time as he transmits a force to the device along the second axis, whereby the first and second protrusions will be pressed against the internal shell surface of the exhaust pipe and are thus brought together, with the result that the first protrusion is guided backward along the first axis. The force which is required to bring together the two protrusions in this position can be a simple raising/lowering motion by the user, whereby one of the two protrusions runs up against the internal shell surface of the exhaust pipe. The bringing together can also be achieved with the aid of a spring arranged between the protrusions.

The locking member can be pretensioned in the direction of the first position. This means that the locking member, in its normal position, engages with the first protrusion. When the first protrusion is advanced by means of the advancement unit, a force is applied along the first axis, which overcomes the friction between the locking member and the first protrusion. The friction is reduced by the advancement unit, during its advancement of the first protrusion, pressing this gently downward with tilting of the advancement member, whereby the radial bearing force between the locking member of the locking unit and the first protrusion is reduced.

The connecting link of the device can be fixed in a joint on the manoeuvering device and in a joint on the second protrusion. This allows a mutual, controlled displacement of the first and second protrusions, so that a displacement of the first protrusion along said first axis imposes a mutual change of position of the first and second protrusions along a second axis, perpendicular to the first axis.

Alternatively, the connecting link with its one end can be guidably received in the manoeuvering device and with its other end is fixed in a joint on the second protrusion. This allows the projecting length of the protrusions relative to the casing of the manoeuvering device to be adjustable, depending on the position of a vehicle exhaust pipe relative to the fender/bumper. At the same time, the mutual, controlled displacement of the first and second protrusions is allowed.

The manoeuvering device can be enclosed by a casing, which casing comprises a socket facing toward the gripping device.

### DESCRIPTION OF DRAWINGS

The invention will be described in greater detail below for illustrative purposes with reference to the accompanying drawings, which show a currently preferred embodiment.

FIG. 1 shows a schematic cross section of the device according to the invention prior to engagement with an exhaust pipe.

FIG. 2 shows a schematic cross section of the device according to the invention when the two protrusions have been moved apart along the second axis into engagement with an exhaust pipe.

FIG. 3 shows schematically the cooperation of a washer with the first protrusion.

FIG. 4 shows schematically the cooperation of the advancement unit and locking unit with the first protrusion.

FIG. 5 shows schematically the connecting link when this is displaced into a rear position relative to the casing.

FIG. 6 shows an alternative embodiment of the cooperation of the washers with the first protrusion.

### TECHNICAL DESCRIPTION

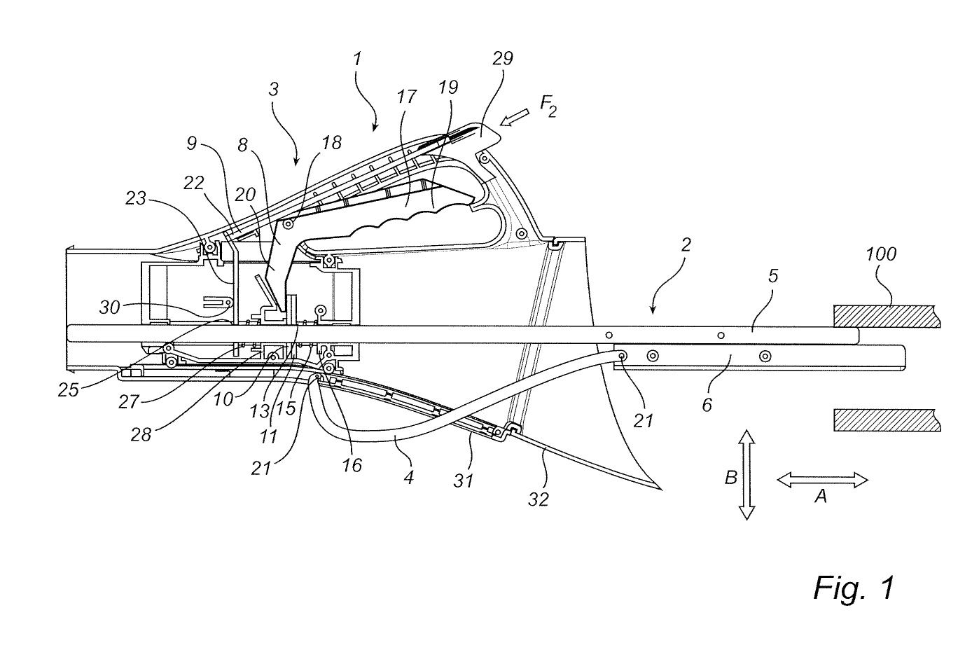

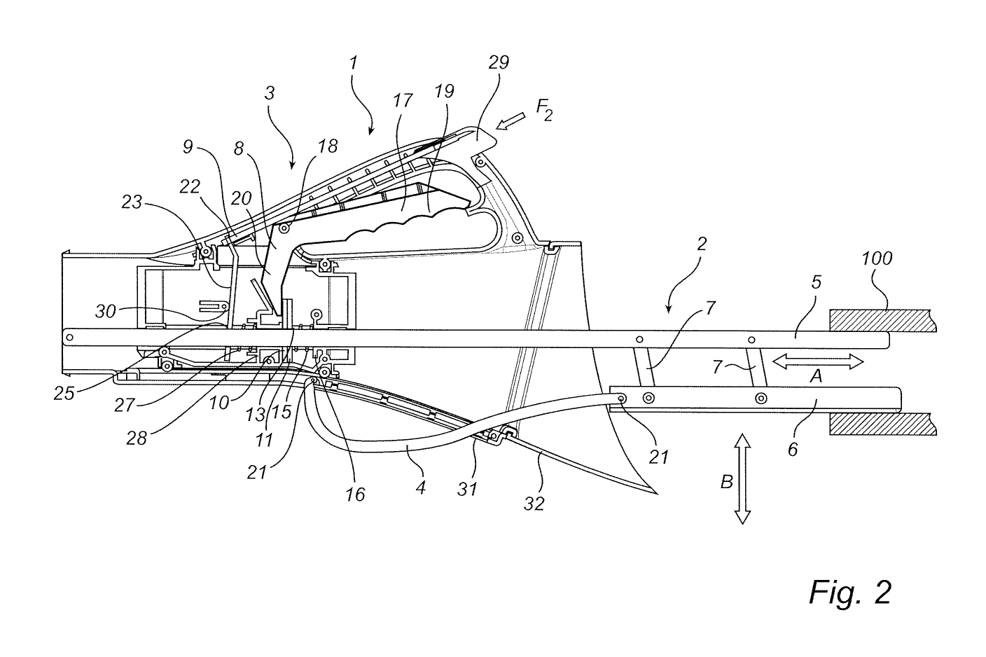

With reference now to FIG. 1 and FIG. 2, a first embodiment is shown of a device 1 for internal gripping of an exhaust pipe 100. The device comprises two main parts: a gripping device 2 for introduction into and internal gripping of the exhaust pipe, and a manoeuvering device 3 for manoeuvering of the gripping device. A connecting link 4 connects the gripping device 2 and the manoeuvering device 3.

The gripping device 2 comprises a first 5 and a second 6 protrusion, which are intended to be introduced into the exhaust pipe. The two protrusions 5, 6 are mutually articulately connected by means of two links 7 extending between the two protrusions. The links 7 can be likened to pendulums, whereby the second protrusion 6, in the shown embodiment the lower one, is allowed to be guided with a translatory motion relative to the first, upper protrusion 5. This means that a displacement of the first protrusion 5 in the axial direction along a first axis A imposes a change in position of the second protrusion 6 along a second axis B, which is perpendicular to the first axis. The two protrusions 5, 6 will hereby be guided in the radial direction of the exhaust pipe 100 and will grip this internally when the first protrusion 5 is guided forward, i.e. away from the manoeuvering device 3.

The protrusions 5, 6 are formed in their simplest embodiment by two elongated profiles made of plastic, metal or composite. The same applies to the links 7 connecting the two protrusions 5, 6. The profiles can have, for example, rectangular or circular cross section. The following description will be based on a rectangular cross section.

The manoeuvering device 3 comprises an advancement unit 8 and a locking unit 9, which both cooperate with the first protrusion 5 to allow displacement of the same along the first axis A.

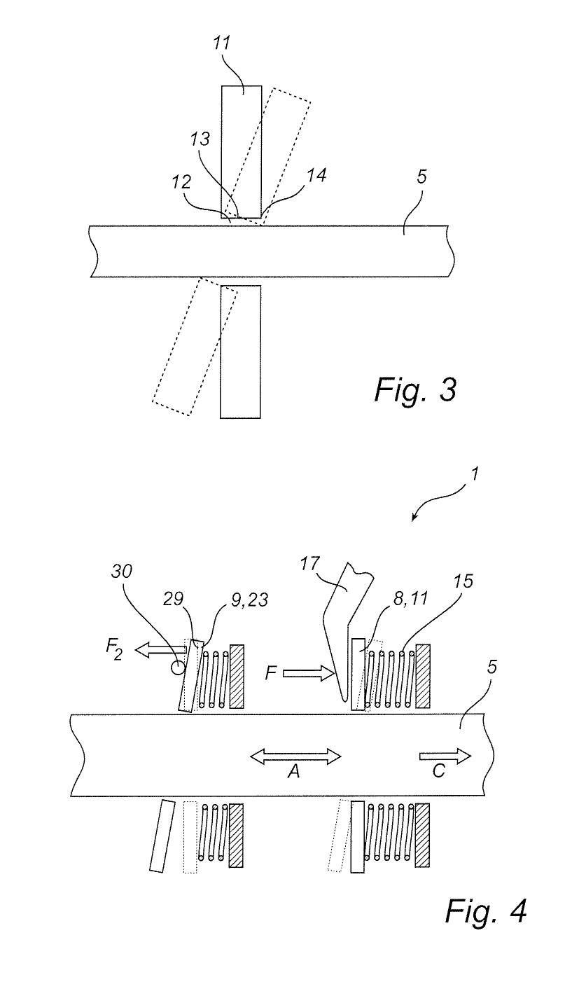

In the shown embodiment, the advancement unit 8 comprises an advancement member 10 in the form of two parallel washers 11. The respective washer 11 has a continuous cutout 12 through which the first protrusion 5 runs. The individual cutout 12, see FIG. 3, has a gripping surface 13 in the form of a hole edge having a rim 14 which can be likened to a lip, which, when the washer 11 is tilted relative to the first protrusion 5, can enter into locking engagement with the latter.

The advancement member 10 is formed in its simplest embodiment by a washer 11, through which the cutout 12 is punched, whereby the rim 14 is formed by the punched hole edge. The cutout 12 can be provided, for example, with two opposite such rim portions, which face in the direction in toward the protrusion, i.e. in the direction of the top side and bottom side respectively of the protrusion, or just with one rim portion, which, when the washer is tilted, will engage with the top side or bottom side of the protrusion. It will be appreciated that, depending on the cross-sectional geometry of the protrusion, alternatively the orientation of the advancement unit relative to the protrusion, the cutout can have a different cross-sectional geometry and/or can be designed to engage with the protrusion on other surfaces than its top side/bottom side. In the shown embodiment, the cutout is rectangular, but it will be appreciated that other geometries are also conceivable. It will further be appreciated that the cutout can be arranged to grip against the corner points of the protrusion profile instead of against its edges.

The number of washers 11 can vary. In the simplest embodiment, one washer is used, which, per se, is sufficient to give a satisfactory engagement with the first protrusion. By using two or more washers, a satisfactory engagement is ensured should wearing or damage occur to one of the washers or to the cross-sectional profile of the first protrusion.

With new reference to FIGS. 1 and 2, the washers 11 are arranged to be adjustable by tilting transversely to the longitudinal axis of the first protrusion 5 between a first position, in which the protrusion can be displaced through the cutout, and a second position, in which the rim, i.e. the gripping surface, of the cutout engages with the protrusion.

The washers 11, in their normal position, are pretensioned in the direction of the first position. The pretensioning can be achieved, for example, by means of a helical spring 15 or leaf spring, which is arranged between two counterstays 16.

The advancement unit 8 comprises a handle 17 for manoeuvering of the advancement member 10. The handle 17 is secured pivotably about a joint 18 in the manoeuvering device 3 and comprises on one side of the joint 18 a gripping surface 19 and on the other side a projection 20. The projection 20 is intended to act against the rear side of the washers 11 of the advancement member 10. When a pressure is applied to the gripping surface 19 of the handle 17, the projection 20 will thus apply a pressure to the washers 11, which are tilted to engage with the first protrusion 5 and thus advance the same by a distance corresponding to the rotary motion of the projection 20 about the articulated attachment point 18 of the handle 17. As a result of the pretensioning 15 of the advancement member 10, its washers 11 will be guided jointly forward upon the advancement of the first protrusion 5, so as then, when the handle 17 is released, to spring back and be straightened into their first position.

A connecting link 4 extends between the gripping device 2 and the manoeuvering device 3. More precisely, the connecting link 4 extends between the manoeuvering device 3 and the second protrusion 6. In the simplest embodiment, both of the attachment points 21 are articulated.

The purpose of the connecting link 4 is to limit the displacement of the protrusion 6 along the first axis A during the displacement of the first protrusion 5 by the advancement unit 8. The connecting link 4 shall thus, in cooperation with the links 7 connecting the first 5 and second protrusion 6, impose upon the second protrusion 6 a pendulum motion in which the second protrusion 6 makes a translation motion which is substantially parallel with the first axis A.

The connecting link 4 is formed in its simplest embodiment by a profile made of plastic, metal or composite. The connecting link can also be formed by a cord/chain or the like.

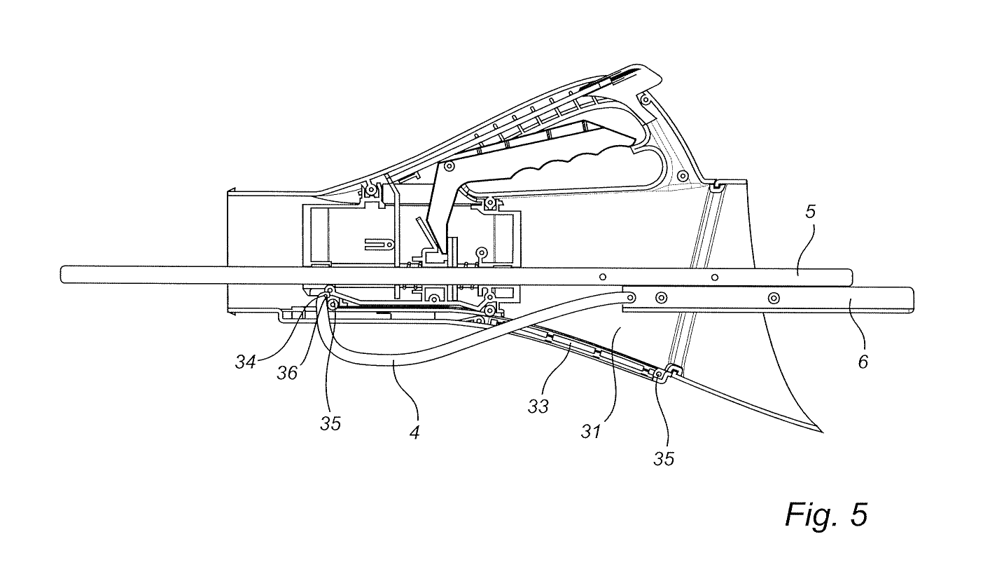

In order to make the device adaptable to different positions of a vehicle exhaust pipe relative to the fender/bumper, it is preferred that the length by which the protrusions 5, 6 jut out from the casing 31 of the manoeuvering device 3 can be altered. In the shown embodiment, this is allowed by the fact that the connecting link 4 can be guided in a groove 33 in the casing 31, see FIG. 5. In order to obtain guidance in the groove 33, the connecting link 4 has at its rear end a pivot 34, extending transversely to the length of the groove, and a hook 36. The groove 33 further has at its ends engagement points 35, with which the hook 36 of the connecting link can engage. By virtue of the fact that the connecting link 4 at its other end is connected to the second protrusion 6, which in turn is connected to the first protrusion 5, these will together be shifted relative to the casing 31. The connecting link 4 is expediently shifted manually by the user gripping it and guiding it between its two end positions, depending on whether the exhaust pipe is arranged far in or close to the bumper/fender.

The manoeuvering device 3 further comprises a locking unit 9. The purpose of the locking unit 9 is firstly to help maintain the displacement of the first protrusion 5 relative to the manoeuvering device 3 while the advancement unit 10 is manoeuvered, i.e. when the washers 11 of the advancement unit 10 are being tilted between their first and second positions, and secondly to allow release of the radial engagement of the two protrusions 5, 6 with the exhaust pipe 100.

In the shown embodiment, the locking unit 9 comprises a locking member 22 in the form of a washer 23 having a cutout 24, through which the first protrusion 5 extends. The washer 23 has the same design as that of the advancement member 10, so that reference is made to the configuration of the above-featuring cutout.

The number of washers 23 can vary. In the simplest embodiment, one washer is used, as shown.

The washer 23 is adjustable, see FIG. 4, by tilting transversely to the longitudinal axis of the first protrusion 5 between a first position, in which the gripping surface 25 formed by the rim 26 on the hole edge of the cutout 24 engages with the first protrusion 5, and a second position, in which the protrusion can be guided through the cutout. The second position is shown in FIG. 4 with dashed lines.

The washer 23 is in its normal position pretensioned in the direction of the first position. The pretensioning can be achieved, for example, by means of a helical spring 27 or leaf spring arranged between two counterstays 28.

In the shown embodiment, the locking unit 9 is manoeuvered by means of a projection 29 connected to the washer 23. The projection 29 is connected to the washer 23 and the washer is in turn arranged pivotably about a point 30 in the manoeuvering device 3.

With reference to FIG. 4, the device 1 is now shown in its neutral position with the washer 23 of the locking unit 9 and the washer 11 (only one is shown) of the advancement unit 8 in their first positions shown with solid lines. The washer 23 of the locking unit 9 is tilted and lockingly engages with the first protrusion 5, while the washer 11 of the advancement unit 8 is upright, free from engagement with the first protrusion 5.

When the user presses in the handle 17, a force F is applied to the washer of the advancement unit, whereby this is tilted (shown with dashed line). The tilt means that the washer 11 lockingly engages with the first protrusion 5 and draws this forward in the direction C of the arrow. As a consequence of this, the washer 23 of the locking unit 9, as a result of its initial engagement with the first protrusion 5, will be rotated up to a more or less upright position, i.e. its second position. The rotation takes place about the point 30. During the rotation motion, the engagement of this washer 23 with the first protrusion 5 will help to advance the latter until the washer 23 has assumed its second position (shown with dashed line) and the protrusion escapes the washer 23 of the locking unit 9.

When the handle 17 is released, the washer 11 of the advancement unit 8 is relieved of load, which means that it will return to its first position by virtue of its pretensioning. At the same time, the pretensioning of the washer 23 of the locking unit 9 causes this to return to its first position in which it lockingly engages with the first protrusion 5. The first protrusion 5 will thereby maintain its advanced position.

This means that the user, by alternately pressing in and releasing the handle 17, can gradually advance the first protrusion 5 along the first axis A. During this step-by-step advancement, the first 5 and second protrusions 6, as a result of the links 7 extending therebetween and the connecting link 4, will cause the two protrusions 5, 6 to be gradually moved apart in the radial direction of the exhaust pipe 100 for internal gripping of the same.

Conversely, when a force F2 is applied to the projection 29 of the locking unit, the motion about the articulated point 30 will straighten the tilt of the washer 23 relative to the first protrusion 5, i.e. the washer 23 is guided to its second position free from engagement with the first protrusion. The fact that the washer of the advancement unit is already in its first position free from engagement with the protrusion means that the latter can be freely guided back in the opposite direction.

The manoeuvering device 3 is arranged in an enclosing casing 31. In the shown embodiment, this casing 31 has at its front end a funnel-like opening to which a socket 32 is connected.

The functioning of the device 1 will be described below with reference to FIGS. 1 and 2.

Upon use, the two protrusions 5, 6 of the device 1 are guided into the exhaust pipe 100. After this, the handle 17 of the advancement unit 8 is pressed in, which means that the following steps are realized more or less in parallel:
1) When the handle 17 is pressed in, the projection 20 of the handle 17 acts upon the washers 11 of the advancement unit 8, which are tilted. The tilt means that the respective washer 11 engages with the first protrusion 5 via the rim 14 on the hole edge of the cutout 12. At the same time, the projection 20 presses the washers 11 forward along the first axis 5 through compression of the spring 15. As a consequence of this engagement, the first protrusion 5 will be guided forward by a distance corresponding to the pendulum motion of the projection 20 about the articulated attachment point 18 of the handle 17.
2) Simultaneously with this, the washer 23 of the locking unit 9, by virtue of its initial engagement with the first protrusion 5, will be rotated about the point 30 into its second position free from engagement with the protrusion. During the rotation motion, the initial engagement of the washer 23 with the first protrusion helps to advance the same. At the same time, the spring 27 is compressed.
3) By the first 5 and second protrusion 6 being mutually articulately connected by means of links 7, the second protrusion 6 will be jointly guided in a translatory motion relative to the first protrusion 5. The links 7 impose a change of position of the second protrusion 6 along the second axis B, which is perpendicular to the first axis A, i.e. the two protrusions 5, 6 will be guided in the radial direction of the exhaust pipe 100 and will grip this internally.
4) When the handle 17 is released, the washers 11 of the advancement unit 8 and the washer 23 of the locking unit 9 spring back into their first positions. This means that the washer 23 of the locking unit 9 re-engages with the first protrusion 5, which will thus maintain its now advanced position relative to the manoeuvering device 3.
5) Steps 1-3 are repeated until the first 5 and second protrusion 6 have obtained a mutual displacement along the second axis B, which results in an internal radial gripping of the exhaust pipe 100, see FIG. 2.
6) In order to release the engagement of the gripping device 2 with the exhaust pipe 100, the projection 29 of the locking unit 9 is pressed in, whereby the washer 23 of the locking unit 9 is angled up into its second position, in which the first protrusion 5 runs freely relative to the cutout 24 of the washer. The washers 11 of the advancement unit 8 are by then already in their first position, in which the first protrusion 5 runs freely relative to the cutout 12 of the washer 11. The protrusions 5, 6 of the device 1 are now free to be pulled out of the exhaust pipe 100, since the friction between the exhaust pipe 100 and the first 5 and second protrusion 6, in combination with the raising/lowering motion which the user will inevitably make upon this motion, affects the mutual position of the protrusions, so that these are brought together. Alternatively, they can be brought together with the aid of a spring arranged between the protrusions.
7) When the user releases the load upon the projection 29 of the locking unit 9, the washer 23 of the locking unit 11 returns, by virtue of its pretensioning 27 and through rotation about the point 30, into its first position in locking engagement with the first protrusion 5.

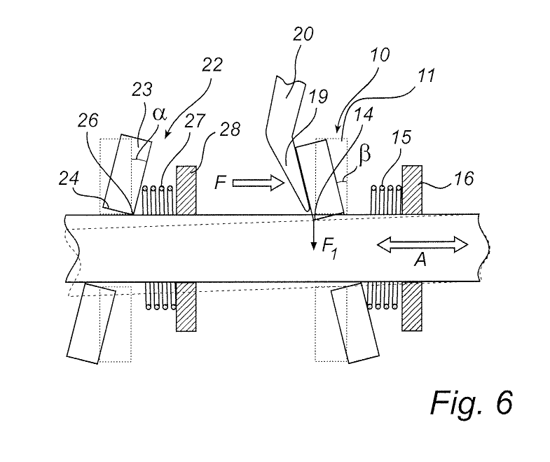

With reference to FIG. 6, an alternative embodiment is shown, in which the washer 23 of the locking unit 9, viewed in a vertical plane in the first position (its locking position), forms a positive angle α (clockwise) relative to the first protrusion 5, while the washers 11 of the advancement unit 8 in the second position (their locking position) form a negative angle β (counterclockwise) relative to the first protrusion 5. The effect of this is that, when the washer 11 of the advancement unit 8 advances the first protrusion 5 by entering into engagement with the same, the washer 23 of the locking unit 9 will allow the first protrusion 5 to pass through it. Conversely, when the washers 11 of the advancement unit 8 relinquish their engagement with the first protrusion 5, the washer 23 of the locking unit 9 will be in locking engagement with the first protrusion 5, so that the latter is maintained in its advanced position. This means that the user, by alternately pressing in and releasing the handle 17, can gradually advance the first protrusion 5 along the first axis A. When the first protrusion 5 is guided forward by means of the washers 11 of the advancement unit 8, said washers, as a result of their tilt, apply a downwardly directed force F1 to the first protrusion 5. This downwardly directed force F1 means that the first protrusion 5 is pressed downward (shown schematically with dashed lines) relative to the washer 23 of the locking unit 11, thereby reducing the friction between them. This means that the locking unit 11, even if it is in its first position in which it lockingly engages with the first protrusion 5, allows the first protrusion to be guided forward along the first axis A. For this purpose, the washer 23 of the locking unit 9 advantageously has a cutout 24 which only engages with a surface of the first protrusion 5.

Above, a description has been given of a specific embodiment of the device. It will be appreciated, however, that this is only one possible embodiment.

The washers in the locking unit and advancement unit respectively have been described as circumferential cutouts. It will be appreciated that the cutouts can be open along a part of their circumference, with maintained functioning.

In the shown embodiment, the advancement member comprises two washers. The invention can be used with both one and a plurality of washers, with maintained functioning. The same applies to the locking unit.

The device can at its rear end comprise rapid coupling members for simple connection to a hose or pipe of an extraction device.

In the shown embodiment, the manoeuvering device uses perforated washers, which are tilted for engagement with the first protrusion for displacement of the same. It will be appreciated that this is only one possible embodiment. The advancement unit and the locking unit, within the scope of the particular claims which define the invention, can be formed, for example, by a pawl with back catch which cooperates with a toothed profile of the first protrusion.

In the shown embodiment, the first protrusion is arranged to be guided forward along a first axis, whereby this results in the second protrusion obtaining a change of position along a second axis, which is perpendicular to the first axis. It will be appreciated that corresponding functioning within the scope of the invention can be obtained by the first protrusion instead being guided backward along the first axis.

It will be appreciated that the present invention is not limited to the shown embodiments. A number of modifications and variants are possible and the invention is consequently defined exclusive by the appended claims.

1. A device for internal gripping of an exhaust pipe, comprising
a gripping device comprising a first and a second protrusion which are mutually connected to allow mutual displacement along a first axis (A), the connection being arranged such that a displacement along said first axis (A) imposes a mutual change of position of the first and second protrusions along a second axis (B), perpendicular to the first axis (A),
a manoeuvering device for achieving said mutual displacement of the first and second protrusions along said first axis (A),
which manoeuvering device comprises
an advancement unit, which is arranged to displace the first protrusion along said first axis (A) in relation to the manoeuvering device, and
a connecting link, which is arranged to connect the manoeuvering device to the second protrusion and to limit the displacement of said second protrusion along the first axis (A) relative to said manoeuvering device during the displacement of the first protrusion by the advancement unit.

2. A device according to claim 1, in which the advancement unit comprises an advancement member, which is adjustable relative to the first protrusion, between a first and a second position,
in which first position the first protrusion is allowed to be displaced along said first axis (A) relative to the advancement member, and
in which second position the advancement member lockingly engages with the first protrusion,
the advancement member in its second position being arranged to be displaced along said first axis (A) and thus to displace said first protrusion along said first axis in relation to the manoeuvering device.

3. A device according to claim 2, in which the advancement member is formed by a washer comprising a cutout cooperating with the first protrusion which washer, in the first position of the advancement member, is arranged guidably over said first protrusion and which washer, in the second position of the advancement member, by tilting, lockingly engages with the first protrusion by means of a gripping surface arranged in the cutout.

4. A device according to a claim 2, in which the advancement member is pretensioned in the direction of the first position.

5. A device according to claim 1, in which the manoeuvering device further comprises a locking unit comprising a locking member which is adjustable relative to the first protrusion between a first and a second position,
in which first position said locking member lockingly engages with the first protrusion and
in which second position the first protrusion is allowed to be displaced along said first axis (A) relative to the locking member.

6. A device according to claim 5, in which said locking member is formed by a washer comprising a cutout cooperating with the first protrusion, which washer, in the second position of the locking member, is arranged guidably over said first protrusion, and which washer, in the first position of the locking member, by tilting, lockingly engages with the first protrusion by means of a gripping surface arranged in the cutout.

7. A device according to claim 5, in which the locking member is pretensioned in the direction of the first position.

8. A device according to claim 1, in which the connecting link is fixed in a joint on the manoeuvering device and in a joint on the second protrusion.

9. A device according to claim 1, in which the connecting link with its one end is guidably received in the manoeuvering device and with its other end is fixed in a joint on the second protrusion.

10. A device according to claim 1, in which the manoeuvering device is enclosed by a casing, which casing comprises a socket facing toward the gripping device.
